(19) United States
(12) Patent Application Publication
(10) Pub. No.: US 2022/0386566 A1
(43) Pub. Date: Dec. 8, 2022

(54) Inclement Weather Pet Safety Device

(71) Applicant: Jarrad Childs, Olean, NY (US)

(72) Inventor: Jarrad Childs, Olean, NY (US)

(21) Appl. No.: 17/830,902

(22) Filed: Jun. 2, 2022

Related U.S. Application Data
(60) Provisional application No. 63/196,969, filed on Jun. 4, 2021.

(51) Int. Cl. A01K 13/00; A01K 27/00

(52) U.S. Cl. CPC A01K 13/006; A01K 27/002

(57) ABSTRACT

The present invention relates to an inclement weather pet safety device which protects pets when exercising outdoors during inclement weather conditions. The device comprises a secure and comfortable wearable harness that fits over the front legs and torso of a dog or other animal. The top of the harness supports a screen or roof configuration positioned over the animal's head and back to maintain protection against inclement weather conditions, excessive heat or cold, etc. In this manner, the inclement weather pet safety device of the present invention provides users with a secure and comfortable wearable harness and roof configuration for protecting pets when exercising outdoors in any type of weather.

### CROSS-REFERENCE TO RELATED APPLICATION

The present application claims priority to, and the benefit of, U.S. Provisional Application No. 63/196,969, which was filed on Jun. 4, 2021 and is incorporated herein by reference in its entirety.

### FIELD OF THE INVENTION

The present invention relates generally to the field of inclement weather devices for pets. More specifically, the present invention relates to an improved pet device that protects pets when walking outside in inclement weather. The device comprises a wearable harness and a screen or roof configured to be positioned over a pet's head and back to protect a pet from inclement weather. Accordingly, the present disclosure makes specific reference thereto. Nonetheless, it is to be appreciated that aspects of the present invention are also equally applicable to other like applications, devices and methods of manufacture.

### BACKGROUND

By way of background, pets can become uncomfortable while outdoors, especially during inclement weather, such as wind, rain, snow, hail, sleet, etc., or during extreme hot or cold weather. Some pets can even experience heat stroke, exhaustion, and other ailments if outdoors for too long without any shade or protection. However, if not taken outside to exercise, pets can become lazy and gain weight, which is also unhealthy. Thus, being able to walk dogs and other pets outside during inclement weather is a necessity.

Furthermore, providing an umbrella for a pet is not new, however most pet umbrellas are independent of a pet's leash and/or harness, which can restrict the pet's movements and cause the umbrella to be skewed from its intended protective position. Further, movement of the pet relative to the harness, collar and/or umbrella may also cause the umbrella to be skewed from its intended protective position overlying the pet to a partially unprotecting position. Accordingly, an improved pet protection for inclement weather is needed.

It is necessary for pet owners to consistently exercise their pets, typically outdoors and sometimes during inclement weather. However, pets can become uncomfortable, and even injured, during inclement weather and/or hot or cold weather extremes. Therefore, users require a device that easily allows them to exercise their pets outdoors during all weather conditions.

Therefore, there exists a long-felt need in the art for an inclement weather pet safety device that provides shade during times of excessive heat. There is also a long-felt need in the art for an inclement weather pet safety device that allows a user to safely exercise their pets outdoors during inclement weather conditions. Further, there is a long-felt need in the art for an inclement weather pet safety device that provides a pet with protection from wind, rain, snow, hail, and/or sleet, while walking outside. Moreover, there is a long-felt need in the art for a device that can be worn on a pet while walking outdoors. Further, there is a long-felt need in the art for a device that is independent of the leash, to allow users to walk their pets while wearing the device. Finally, there is a long-felt need in the art for an inclement weather pet safety device that provides a roof in an upright position, allowing users to exercise their pets without impeding use of a leash.

The subject matter disclosed and claimed herein, in one embodiment thereof, comprises an inclement weather pet safety device. The device is designed to protect pets when exercising outdoors during inclement weather conditions. The device comprises a secure and comfortable wearable harness that fits over the front legs and torso of a dog or other animal. The top of the harness supports a screen, or roof configuration, positioned over the animal's head and back to maintain protection against inclement weather conditions, excessive heat or cold, etc. The roof or screen is supported via a frame system comprising a pair of sleeves and a plurality of tubular frame members which act to retain the roof in an upright position, so as not to impede use of a leash.

In this manner, the inclement weather pet safety device of the present invention accomplishes all of the forgoing objectives and provides users with a device that protects pets when exercising outdoors during inclement weather conditions. The device provides a secure and comfortable wearable harness and roof configuration for protecting pets when exercising outdoors. The device allows pets to be able to exercise outdoors in any type of weather.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an inclement weather pet safety device. The device is designed to protect pets when exercising outdoors during inclement weather conditions. The device comprises a secure and comfortable wearable harness that fits over the front legs and torso of a dog or other animal. The wearable harness can be manufactured in a variety of sizes and shapes, depending on the size of the user's pet(s). The harness is typically secured around the torso of a pet via a general securing means, such as Velcro, snaps, clasps, zipper, etc., or any other suitable securing means as is known in the art. The harness would be manufactured from a nylon, a plastic, a polymer, etc., or any other suitable material as is known in the art.

The top of the harness supports a roof and/or screen configuration. The roof and/or screen is typically a flat, rectangular component, but can be any suitable shape as is known in the art. The roof and/or screen is positioned over the animal's head and back to maintain protection against inclement weather conditions, excessive heat or cold, etc. The roof and/or screen would be manufactured from a nylon, a plastic, a polymer, etc., or any other suitable material as is known in the art.

The roof and/or screen is supported via a frame system comprising a pair of sleeves and a plurality of tubular frame members which act to retain the roof in an upright position so as not to impede use of a leash. Specifically, the pair of sleeves are positioned on the back of the harness, at opposing side ends. The pair of sleeves support a nonrigid, rectangular roof component therebetween. The pair of sleeves are sized to accept a tubular frame member, such that once the tubular frame member is slid into each sleeve, the nonrigid, rectangular roof component is drawn taunt creating a rigid roof component. Additional tubular frame members contact the rigid roof component at a midpoint of the roof and at the rear of the roof, to support the roof at an angle above the head of the pet. The tubular frame members can contact the roof component at any point or multiple points along the roof component, as long as the roof component is supported in an upright position above the head and back of an animal. The plurality of tubular frame members are secured to the roof and/or screen via the pair of sleeves, glue, clasps, etc., or any other suitable securing means as is known in the art.

In another embodiment, the roof component is supported at an angle above the head of a pet. Specifically, the roof component is supported at a 45 degree angle above the head of a pet. Generally, the roof component is supported at an angle between 30-50 degrees above the head of a pet.

In one embodiment, the plurality of tubular frame members are pivotally coupled at a rear end of the roof component, at opposing sides, and at a middle position of the roof component, at opposite ends of the roof component to support the roof component in a raised position. The ends of the tubular frame members are then secured directly to the wearable harness.

In another embodiment, the rear end of the roof component is integrated with the wearable harness as a singular piece. Thus, once the tubular frame members are inserted into the attached sleeves, a set of tubular frame members are then secured to only the middle position of the roof component, at opposing ends, to support the roof component in a raised position. The ends of the tubular frame members are then secured directly to the wearable harness.

In another embodiment, the roof component is independent of the wearable harness. In this embodiment, the rear end of the roof component is sewn or glued directly to the wearable harness. One tubular frame member, configured in a U-shaped position, is then secured to the middle position of the roof component. The U-shaped tubular frame member is then secured to the middle of the roof component via the U-shaped member, allowing the opposing ends of the U-shaped frame member to secure directly to the wearable harness. The opposing ends of the U-shaped frame member support the roof component in a raised position.

In one embodiment, the roof and/or screen is supported at such an angle above the head of a pet that the pet can wear a collar and attached leash without contacting the roof and/or screen. Thus, a user can utilize the roof and/or screen of the device without impeding use of the leash when exercising.

In another embodiment, the inclement weather pet safety device comprises an opening within the roof and/or screen to allow a leash to be threaded through during use. In this embodiment, the leash is threaded through the opening and secured to a latch component on the back of the harness. This allows use of the leash without restricting a pet's movements while exercising.

In another embodiment, the inclement weather pet safety device comprises a latch component for securing a leash, positioned on the roof and/or screen. This allows use of the leash without restricting a pet's movements and without causing the roof and/or screen to be skewed from its intended protective position over the head and back of a pet.

In another embodiment, the inclement weather pet safety device comprises a plurality of indicia on the harness and/or the roof of the device.

In yet another embodiment, the inclement weather pet safety device is manufactured from a material that is water resistant.

In yet another embodiment, a method of protecting a pet from inclement weather conditions when exercising outdoors is described. The method includes the steps of providing an inclement weather pet safety device for the pet, wherein the device comprises a wearable harness and a roof component. The method also comprises putting the wearable harness on the pet, such that the harness fits over the front legs and torso of the pet. Further, the method comprises positioning the roof component over the pet's head and back to provide protection against inclement weather conditions. The roof component is positioned via inserting tubular frame members into the pair of support sleeves to create a rigid roof component. Finally, attaching a leash to the pet and exercising the pet outdoors.

In yet another embodiment of the present invention, an inclement weather pet safety device is disclosed for protecting pets when exercising outdoors during inclement weather conditions. The device comprises a secure and comfortable wearable harness that fits over the front legs and torso of a dog or other animal. The top of the harness supports a screen or roof configuration, positioned over the animal's head and back to maintain protection against inclement weather conditions, excessive heat or cold, etc. In this manner, the inclement weather pet safety device of the present invention provides users with a secure and comfortable wearable harness and roof configuration for protecting pets when exercising outdoors in any type of weather.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the inclement weather pet safety device of the present invention in use during rainy conditions in accordance with the disclosed architecture;

FIG. 2 illustrates a side perspective view of another potential embodiment of the wearable harness and roof configuration of the inclement weather pet safety device of the present invention in accordance with the disclosed architecture;

FIG. 3A illustrates a side perspective view of one potential embodiment of the inclement weather pet safety device of the present invention shown on a dog in accordance with the disclosed architecture;

FIG. 3B illustrates a front perspective view of one potential embodiment of the inclement weather pet safety device of the present invention shown on a dog in accordance with the disclosed architecture;

FIG. 4 illustrates a close-up perspective view of one potential embodiment of the harness and roof configuration of the inclement weather pet safety device of the present invention in accordance with the disclosed architecture;

FIG. 5A illustrates a perspective view of one potential embodiment of the inclement weather pet safety device of the present invention in use during inclement weather conditions in accordance with the disclosed architecture;

FIG. 5B illustrates a perspective view of one potential embodiment of the inclement weather pet safety device of the present invention in use during inclement weather conditions in accordance with the disclosed architecture; and

FIG. 6 illustrates a flowchart showing the method of protecting a pet from inclement weather conditions when exercising outdoors in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an inclement weather pet safety device that provides shade during times of excessive heat. There is also a long-felt need in the art for an inclement weather pet safety device that allows a user to safely exercise their pets outdoors during inclement weather conditions. Further, there is a long-felt need in the art for an inclement weather pet safety device that provides a pet with protection from wind, rain, snow, hail, and/or sleet, while walking outside. Moreover, there is a long-felt need in the art for a device that can be worn on a pet while walking outdoors. Further, there is a long-felt need in the art for a device that is independent of the leash, to allow users to walk their pets while wearing the device. Finally, there is a long-felt need in the art for an inclement weather pet safety device that provides a roof in an upright position, allowing users to exercise their pets without impeding use of a leash.

The present invention, in one exemplary embodiment, is an inclement weather pet safety device. The device comprises a secure and comfortable wearable harness that fits over the front legs and torso of a dog or other animal. The top of the harness supports a screen or roof configuration positioned over the animal's head and back to maintain protection against inclement weather conditions, excessive heat or cold, etc. The present invention also includes a novel method of protecting a pet from inclement weather conditions when exercising outdoors. The method includes the steps of providing an inclement weather pet safety device for the pet, wherein the device comprises a wearable harness and a roof component. The method also comprises putting the wearable harness on the pet, such that the harness fits over the front legs and torso of the pet. Further, the method comprises positioning the roof component over the pet's head and back to provide protection against inclement weather conditions. Finally, attaching a leash to the pet and exercising the pet outdoors.

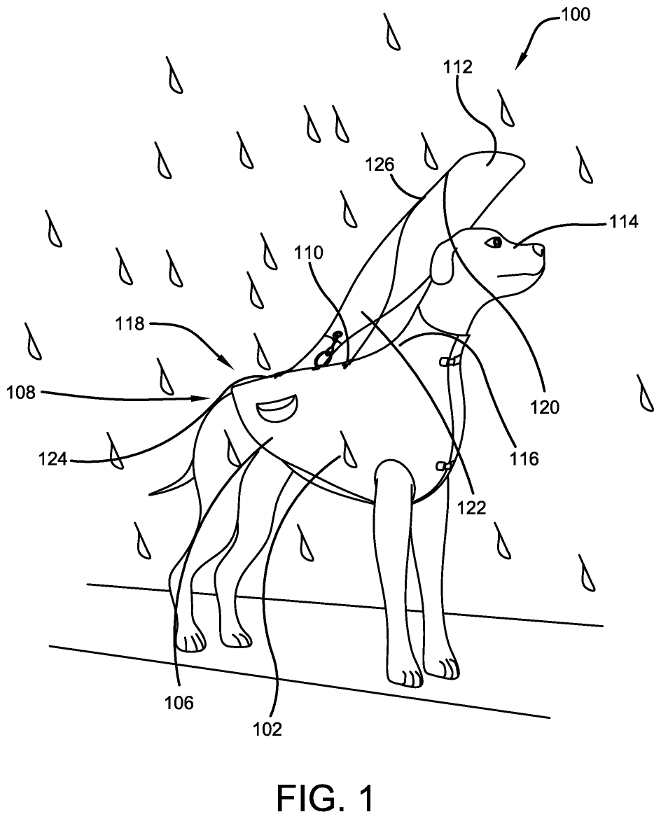

Referring initially to the drawings, FIG. 1 illustrates a perspective view of one embodiment of the inclement weather pet safety device 100 of the present invention. In the present embodiment, the inclement weather pet safety device 100 is an improved pet protection device that protects a pet from inclement weather conditions when exercising outdoors. The device 100 is especially designed to allow a pet owner or any other suitable user as is known in the art, to easily protect their pet when exercising outdoors. More specifically, the device 100 comprises a secure and comfortable, wearable harness 102 that fits over the front legs 104 and torso 106 of a dog 108 or other animal, etc. The animal can be any suitable pet as is known in the art, depending on the needs and/or wants of a user.

The wearable harness 102 can be manufactured in a variety of sizes and shapes, depending on the size of the user's pet(s). The harness 102 is typically secured around the torso 106 of a pet via a general securing means, such as at least one fastener 103 that may be hook and loop straps, snaps, clasps, zipper, etc., or any other suitable securing means as is known in the art, depending on the needs and/or wants of a user. In an embodiment wherein the fastener 103 is a hook and loop strap, the straps may further be supported by at least one adjustable buckle 105

The harness 102 would typically be manufactured from a nylon, a plastic, a polymer, etc., or any other suitable material as is known in the art, such as, but not limited to, polypropylene, acrylonitrile-butadiene-styrene (ABS), polycarbonate, polyethylene, thermoplastic, low density polyethylene, medium density polyethylene, high density polyethylene, polyethylene terephthalate, polyvinyl chloride, polystyrene, polylactic acid, acetal, etc. Generally, the harness 102 is also manufactured from a material that is water resistant or water permeable, or the outer covering comprises a coating that is water resistant or water permeable.

Furthermore, the top 110 of the harness 102 supports a roof and/or screen configuration (or component) 112. The roof and/or screen component 112 is typically a flat, rectangular component, but can be any suitable shape as is known in the art, depending on the needs and/or wants of a user. The roof and/or screen component 112 is positioned over the animal's head 114 and back 116 to maintain protection against inclement weather conditions, such as wind, rain, snow, sleet, hail, excessive heat or cold, etc., or any other suitable weather conditions as is known in the art.

The roof and/or screen component 112 would be manufactured from a nylon, a plastic, a polymer, etc., or any other suitable material as is known in the art, such as, but not limited to, polypropylene, acrylonitrile-butadiene-styrene (ABS), polycarbonate, polyethylene, thermoplastic, low density polyethylene, medium density polyethylene, high density polyethylene, polyethylene terephthalate, polyvinyl chloride, polystyrene, polylactic acid, acetal, etc. Generally, the roof component 112 is also manufactured from a material that is water resistant or water permeable, or the outer covering comprises a coating that is water resistant or water permeable.

Generally, the roof or screen component 112 is supported via a frame system 118 comprising a pair of sleeves 120 and a plurality of tubular frame members 122, which act to retain the roof component 112 in an upright position so as not to impede use of a leash. Specifically, the pair of sleeves 120 are positioned on the back 124 of the harness 102 at opposing side ends 126 of the roof component 112. Typically, the pair of sleeves 120 are integrated with the harness 102 as a single component, but can also be independent of the harness 102 and secured to the harness 102 via any suitable securing means as is known in the art, such as Velcro, sewn, clasps, etc. The pair of sleeves 120 support a nonrigid, rectangular roof component 112 therebetween. The pair of sleeves 120 are sized to accept a tubular frame member 122 such that once the tubular frame member 122 is slid into each sleeve, the nonrigid, rectangular roof component 112 is drawn taunt creating a rigid roof component 112.

Further, additional tubular frame members 122 contact the rigid roof component 112 at a midpoint 128 of the roof 112 and at the rear 130 of the roof 112 to support the roof 112 at an angle above the head 114 of the pet (or dog) 108. The tubular frame members 122 can contact the roof component 112 at any point or multiple points along the roof component 112 as long as the roof component 112 is supported in an upright position above the head 114 and back 116 of an animal 108. The plurality of tubular frame members 122 are secured to the roof component 112 via the pair of sleeves 120, glue, clasps, etc., or any other suitable securing means as is known in the art.

In another embodiment, the roof component 112 is supported at an angle above the head 114 of a pet 108. Specifically, the roof component 112 is supported at a 45 degree angle above the head 114 of a pet 108. Generally, the roof component 112 is supported at an angle between 30-50 degrees above the head 114 of a pet 108, depending on the needs and/or wants of a user. The roof component 112 may further be comprised of at least one eyelet 700 that can further receive a key ring 702 and a clip 704 that can be used to clip a leash to the device 100. The harness 102 may also be comprised of a ring 708 that can receive a leash.

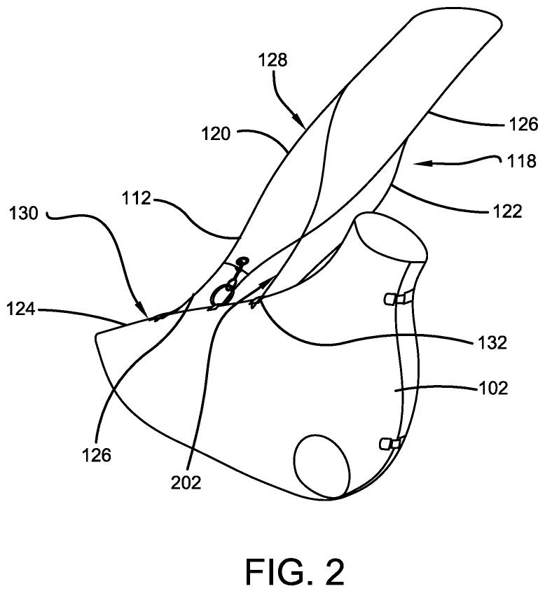

FIG. 2 illustrates a perspective view of another embodiment of the inclement weather pet safety device 100 of the present invention. In this embodiment, the plurality of tubular frame members 122 are pivotally coupled at a rear end 130 of the roof component 112, at opposing sides 126, and at a middle position 128 of the roof component 112, at opposite ends 126 of the roof component 112 to support the roof component 112 in a raised position. The ends 132 of the tubular frame members are then secured directly to the wearable harness 102. The harness 102 may further be comprised of at least one pocket 706 that is further comprised of at least one fastener 103 such as but not limited to: hook and loop, snaps, clasps, zipper, etc. that allows the pocket 706 to be securely closed. The pocket 706 is preferably manufactured from the same material as the harness 102 and matches the harness in appearance.

In another embodiment, the rear end 130 of the roof component 112 is integrated with the wearable harness 102, as a singular piece. Thus, once the tubular frame members 122 are inserted into the attached sleeves 120, a set of tubular frame members 122 are then secured to only the middle position 128 of the roof component 112 at opposing ends 126 to support the roof component 112 in a raised position. The ends 132 of the tubular frame members 122 are then secured directly to the wearable harness 102.

In another embodiment, the roof component 112 is independent of the wearable harness 102. In this embodiment, the rear end 130 of the roof component 112 is sewn or glued directly to the wearable harness 102. One tubular frame member 122, configured in a U-shaped position, is then secured to the middle position 128 of the roof component 112. The U-shaped tubular frame member 200 is then secured to the middle 128 of the roof component 112 via the U-shaped member 200 allowing the opposing ends 202 of the U-shaped frame member 200 to secure directly to the wearable harness 102. The opposing ends 202 of the U-shaped frame member 200 support the roof component 112 in a raised position. The U-shaped member 200 and frame member 122 and rear end of roof 130 may further be secured to the harness 102 via at least one fastener 103 such as but not limited to: hook and loop, snaps, clasps, zipper, etc.,

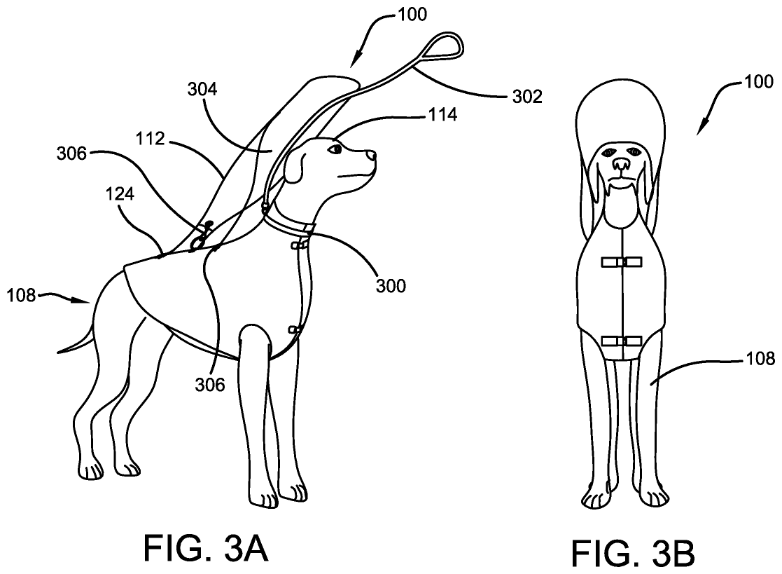

FIGS. 3A-B illustrate a perspective view of another embodiment of the inclement weather pet safety device 100 of the present invention. In this embodiment, the roof component 112 is supported at such an angle above the head 114 of a pet 108 such that the pet 108 can wear a collar 300 and attached leash 302 without contacting the roof component 112. Thus, a user can utilize the roof component 112 of the device 100 without impeding use of the leash 302 when exercising.

In another embodiment, the inclement weather pet safety device 100 comprises an opening 304 within the roof component 112 to allow a leash 302 to be threaded through during use. In this embodiment, the leash 302 is threaded through the opening 304 and secured to a latch component 306 on the back 124 of the harness 102. This allows use of the leash 302 without restricting a pet's movements while exercising.

In another embodiment, the inclement weather pet safety device 100 comprises a latch component 306 for securing a leash 302 positioned on the roof component 112. The latch component 306 can be any suitable securing means as is known in the art, depending on the wants and/or needs of a user. This allows use of the leash 302 without restricting a pet's movements and without causing the roof component 112 to be skewed from its intended protective position over the head 114 and back 116 of a pet 108.

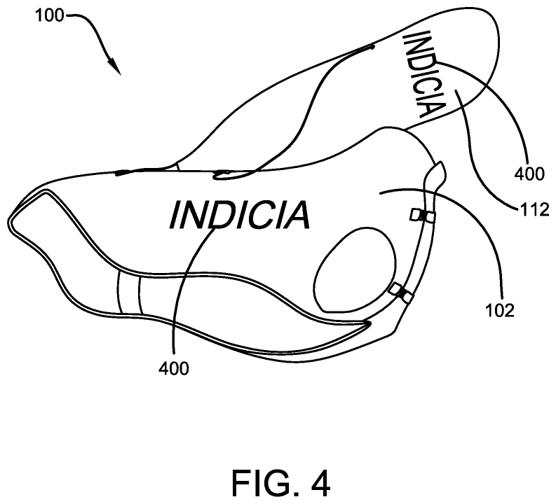

FIG. 4 illustrates a perspective view of another embodiment of the inclement weather pet safety device 100 of the present invention. In this embodiment, the inclement weather pet safety device 100 comprises a plurality of indicia 400 on the harness 102 and/or the roof component 112 of the device 100. Specifically, the harness 102 and/or the roof component 112 of the device 100 may include advertising, a trademark, or other letters, designs, or characters, printed, painted, stamped, or integrated into the device 100, or any other indicia 400 as is known in the art. Specifically, any suitable 400 indicia as is known in the art can be included, such as, but not limited to, patterns, logos, emblems, images, symbols, designs, letters, words, characters, animals, advertisements, brands, etc., that may or may not be pet device/brand related.

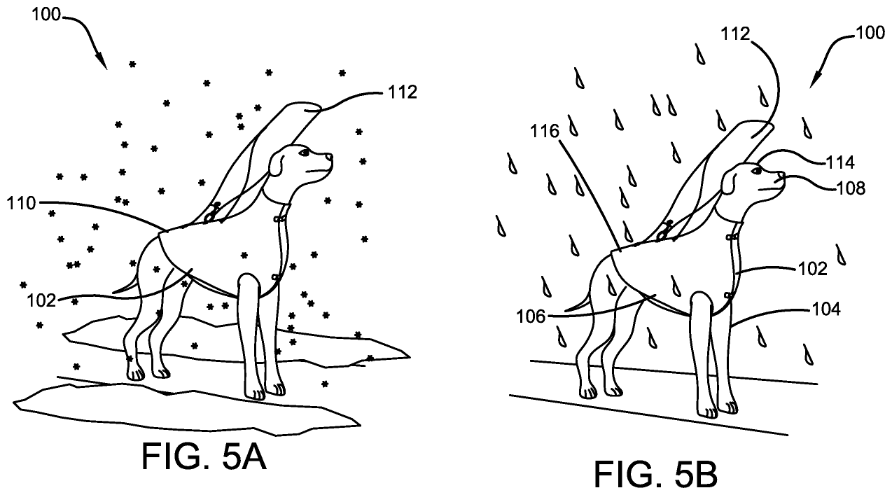

FIGS. 5A-B illustrate a perspective view of another embodiment of the inclement weather pet safety device 100 of the present invention in use during inclement weather. The device 100 provides protection for pets when exercising outdoors during inclement weather conditions. The device 100 comprises a secure and comfortable wearable harness 102 that fits over the front legs 104 and torso 106 of a dog 108 or other animal. The top 110 of the harness 102 supports a screen or roof configuration (or component) 112 positioned over the animal's head 114 and back 116 to maintain protection against inclement weather conditions, excessive heat or cold, etc. In this manner, the inclement weather pet safety device 100 of the present invention provides users with a secure and comfortable wearable harness 102 and roof component 112 for protecting pets 108 when exercising outdoors in any type of weather, as best shown in FIGS. 5A-B.

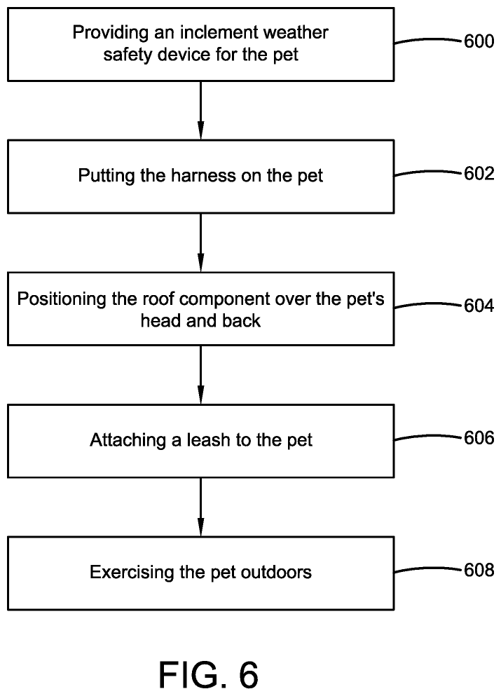

FIG. 6 illustrates a flowchart of the method of protecting a pet from inclement weather conditions when exercising outdoors. The method includes the steps of, at 600, providing an inclement weather pet safety device for the pet, wherein the device comprises a wearable harness and a roof component. The method also comprises, at 602, putting the wearable harness on the pet, such that the harness fits over the front legs and torso of the pet. Further, the method comprises, at 604, positioning the roof component over the pet's head and back to provide protection against inclement weather conditions. The roof component is positioned via inserting tubular frame members into the pair of support sleeves to create a rigid roof component and then securing the tubular frame member to points on the harness, such that the rigid roof component is supported in an upright position. Finally, at 606, attaching a leash to the pet and at 608, exercising the pet outdoors.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “inclement weather pet safety device” and “device” are interchangeable and refer to the inclement weather pet safety device 100 of the present invention.

Notwithstanding the foregoing, the inclement weather pet safety device 100 of the present invention can be of any suitable size and configuration as is known in the art without affecting the overall concept of the invention, provided that it accomplishes the above-stated objectives. One of ordinary skill in the art will appreciate that the inclement weather pet safety device 100 as shown in FIGS. 1-6 is for illustrative purposes only, and that many other sizes and shapes of the inclement weather pet safety device 100 are well within the scope of the present disclosure. Although the dimensions of the inclement weather pet safety device 100 are important design parameters for user convenience, the inclement weather pet safety device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An inclement weather pet safety device for protecting a pet from an inclement weather condition when exercising outdoors, the inclement weather pet safety device comprising:
a harness; and
a roof component;
wherein a top of the harness supports the roof component;
wherein the roof component is positioned over a head and a back of the pet to maintain protection against the inclement weather condition; and
wherein the roof component is supported on the top of the harness via a frame system.

2. The inclement weather pet safety device of claim 1, wherein the harness is sized and configured to fit over a pair of front legs and a torso of the pet.

3. The inclement weather pet safety device of claim 2, wherein the harness is secured around the torso of the pet via at least one of a hook and loop fastener, a snap, a clasp or a zipper.

4. The inclement weather pet safety device of claim 3, wherein the harness is manufactured from a water resistant material.

5. The inclement weather pet safety device of claim 1, wherein the roof component is a flat, rectangular component.

6. The inclement weather pet safety device of claim 5, wherein the frame system comprises a pair of sleeves and a plurality of tubular frame members.

7. The inclement weather pet safety device of claim 6, wherein the pair of sleeves are positioned on a back of the harness, at a pair of opposing side ends of the roof component.

8. The inclement weather pet safety device of claim 7, wherein each of the pair of sleeves are sized and configured to accept at least one of the plurality of tubular frame members, such that once the at least one of the plurality of tubular frame member is slid into each of the pair of sleeves, the roof component is drawn taunt for use.

9. The inclement weather pet safety device of claim 8, wherein the plurality of tubular frame members are secured at a midpoint and at a rear of the roof component, to support the roof component at an angle above the head of the pet.

10. The inclement weather pet safety device of claim 8, wherein the roof component is integrated with the harness as a single piece.

11. The inclement weather pet safety device of claim 10, wherein the plurality of tubular frame members are secured at a midpoint of the roof component, to support the roof component at an angle above the head of the pet.

12. The inclement weather pet safety device of claim 8, wherein the roof component is independent of the harness.

13. The inclement weather pet safety device of claim 12, wherein a U-shaped tubular frame member is secured at a midpoint of the roof component to support the roof component at an angle above the head of the pet.

14. An inclement weather pet safety device for protecting a pet from an inclement weather condition when exercising the pet outdoors, inclement weather pet safety device comprising:
a harness; and
a roof component positioned over a head and a back of the pet to maintain protection against the inclement weather condition;
wherein the roof component is supported on a top of the harness via a frame system;
wherein the frame system comprises a pair of sleeves and a plurality of tubular frame members;
wherein the pair of sleeves are positioned on a back of the harness and at a pair of opposing side ends of the roof component;
wherein each of the pair of sleeves are sized and configured to accept at least one of the plurality of tubular frame members, such that once the at least one tubular frame member is slid into each of the pair of sleeves, the roof component is drawn taunt for use; and
wherein the plurality of tubular frame members are secured at a midpoint and at a rear of the roof component to support the roof component at an angle above the head of the pet.

15. The inclement weather pet safety device of claim 14, wherein the roof component comprises an opening that is sized and configured to accept a leash threaded therethrough.

16. The inclement weather pet safety device of claim 14, wherein the angle of the roof component in relation to the head of the pet allows the pet to wear a collar and a leash without contacting the roof component.

17. The inclement weather pet safety device of claim 14, wherein the roof component comprises a latch component for securing a leash.

18. The inclement weather pet safety device of claim 14, wherein each of the roof component and the harness comprise a plurality of indicia.

19. A method of protecting a pet from an inclement weather condition when exercising the pet outdoors, the method comprising the steps of:
providing an inclement weather pet safety device for the pet, wherein the inclement weather pet safety device comprises a wearable harness and a roof component;
putting the wearable harness on the pet, such that the wearable harness fits over a pair of front legs and a torso of the pet;
positioning the roof component over a head and a back of the pet to provide protection against the inclement weather condition;
attaching a leash to the pet; and
exercising the pet outdoors.

20. The method of claim 19, wherein the roof component is positioned via inserting a tubular frame member into each of a pair of support sleeves to create a rigid roof component and then securing the tubular frame member to points on the harness, such that the rigid roof component is supported in an upright position.
